(19) United States
(12) Patent Application Publication
(10) Pub. No.: US 2005/0093423 A1
(43) Pub. Date: May 5, 2005

(54) Redundant flat lamp system

(76) Inventors: Brian D. Cull, Glendale, AZ (US); Elias S. Haim, Glendale, AZ (US); Allan E. Harris, Phoenix, AZ (US); John F. Schmidt, Phoenix, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/698,770

(22) Filed: Oct. 31, 2003

(51) Int. Cl. H01J 1/62

(52) U.S. Cl. 313/493

(57) ABSTRACT

A flat lamp system is provided that facilitates improved reliability and performance in a display system. The flat lamp system provides improved reliability by forming multiple lamps in a single substrate. These multiple lamps provide redundancy and thus increase the reliability of system. Specifically, when one or more lamps in the system fails, the remaining lamps can be used to provide the luminance needed for the display. The multiple lamps are provided by forming multiple distinct channels in the substrate, and forming a cathode at each end of each channel. Each channel and its corresponding cathodes comprise a lamp that can be used to light the display.

### FIELD OF THE INVENTION

This invention generally relates to displays, and more specifically applies to improved reliability in displays

### BACKGROUND OF THE INVENTION

Various types of optical displays are commonly used in a wide variety of applications. In many applications, the reliability of the display is of critical importance. For example, in vehicles such as aircraft, optical displays can be used to provide important performance and safety information to the operator. In these applications, the critical nature of the information provided to operator demands high performance and reliability from the optical display.

Unfortunately, many optical display systems have limited reliability. In these displays, the failure of one critical part can render the entire display inoperable. For many applications, this can lead to unacceptably high failure rates. For example, electronic displays are commonly used in aircraft to provide a wide range of critical information to the crew. In such aircraft applications, the reliability of the display is of utmost importance, and even very low failure rates can be unacceptable.

One area where optical displays can exhibit failure is in the lamp illuminating the display. Display lamps can fail in many ways. As one example failure mode, typical fluorescent lamps can fail when one of the cathodes providing electrical charge to the lamp breaks down. When the cathode begins to fail, the performance of the lamp can quickly degrade and in many cases is rendered totally inoperable. In many applications, even a partial degradation of lamp performance can unacceptably degrade the performance of the display. Furthermore, in most cases a complete failure in the lamp illuminating the display will render the display totally inoperable. Again, in applications such as aircraft displays, such failures can be unacceptable even at very low failure rates.

Thus, what is needed is an improved lamp system that provides the improved performance and reliability needed for critical applications.

### BRIEF SUMMARY OF THE INVENTION

The present invention provides a flat lamp system that facilitates improved reliability and performance in a display system. The flat lamp system provides improved reliability by forming multiple lamps in a single substrate. These multiple lamps provide redundancy and thus increase the reliability of system. Specifically, when one or more lamps in the system fails, the remaining lamps can be used to provide the luminance needed for the display. The multiple lamps are provided by forming multiple distinct channels in the substrate, and forming a cathode at each end of each channel. Each channel and its corresponding cathodes comprise a lamp that can be used to light the display.

In one embodiment, the flat lamp system includes multiple co-planer interdigitated channels formed in the substrate. The channels are co-planer in that they are formed in the same plane of the substrate. The channels are interdigitated such that each lamp can provide substantially equivalent luminance to the display. Thus, by forming the channels interdigitated with each other, each of the multiple lamps can provide the light needed for the display and thus can effectively serve as replacement light sources for each other. This redundancy again can be used to improve the reliability of the display system.

In another embodiment, a multiple lamp flat lamp system can be provided in a stacked configuration. In general, the stacked flat lamp system comprises a first flat lamp coupled to a second flat lamp. When the first lamp fails, the second lamp can be used to provide illumination to the display. Specifically, light from the second lamp can pass from the second lamp to the first lamp, where it can exit the first lamp and illuminate the display. Thus, either the first lamp or the second lamp can be used to provide illumination for the display. Thus, the first and second lamps provide redundancy, with this redundancy used to improve the reliability of the display system.

The foregoing and other objects, features and advantages of the invention will be apparent from the following more particular description of a preferred embodiment of the invention, as illustrated in the accompanying drawings.

### BRIEF DESCRIPTION OF DRAWINGS

The preferred exemplary embodiment of the present invention will hereinafter be described in conjunction with the appended drawings, where like designations denote like elements, and:

FIG. 1 is a top view of a flat fluorescent lamp;

FIG. 2 is a cross sectional view of the flat fluorescent lamp;

FIG. 3 is a top view of a second embodiment flat fluorescent lamp;

FIG. 4 is a cross sectional view of the second embodiment flat fluorescent lamp;

FIG. 5 is a top view of a third embodiment flat fluorescent lamp;

FIG. 6 is a cross sectional view of the third embodiment flat fluorescent lamp;

FIG. 7 is a cross sectional view of a stacked flat fluorescent lamp; and

FIG. 8 is a partial cross sectional view of a stacked flat fluorescent lamp.

### DETAILED DESCRIPTION OF THE INVENTION

The present invention provides a flat lamp system that facilitates improved reliability and performance in a display system. The flat lamp system provides improved reliability by forming multiple lamps in a single substrate. These multiple lamps provide redundancy and thus increase the reliability of system. Specifically, when one or more lamps in the system fails, the remaining lamps can be used to provide the luminance needed for the display. The multiple lamps are provided by forming multiple distinct channels in the substrate, and forming a cathode at each end of each channel. Each channel and its corresponding cathodes comprise a lamp that can be used to light the display.

In one embodiment, the flat lamp system includes multiple co-planer interdigitated channels formed in the substrate. The channels are co-planer in that they are formed in the same plane of the substrate. The channels are interdigitated such that each lamp can provide substantially equivalent luminance to the display. Thus, by forming the channels interdigitated with each other, each of the multiple lamps can provide the light needed for the display and thus can effectively serve as replacement light sources for each other. This redundancy again can be used to improve the reliability of the display system.

In general, flat lamps are fluorescent lamps constructed from a substrate in which channels are formed. A transparent cover is bonded to the substrate, sealing the channels to form the enclosures that make up lamps in the flat lamp system. In typical implementations, an emissive material that fluoresces in the visible spectrum (e.g., phosphorus) is coated on at least a portion of the channels. The channels are then flushed are filled with a low-pressure gas such as argon, and an electron source material such as mercury. Cathodes are formed at each end of the channel to facilitate electrical connection to the lamp. During lamp operation, the emissive material emits electrons via thermionic emission caused by the electric potential between the two cathodes, causing the emissive material to fluoresce and provide light. More information about flat lamps can be found at U.S. Pat. No. 6,218,776 issued to Brian D. Cull et al and assigned to Honeywell International Inc.

Flat lamps are increasingly being used as light sources in a variety of displays in place of more conventional tubular lamps. For example, flat lamps are used to provide illuminations for liquid crystal displays in a manner similar to tubular fluorescent lamps. The flat lamps are thus a low profile means to generate white light to illuminate the information displayed on the LCD.

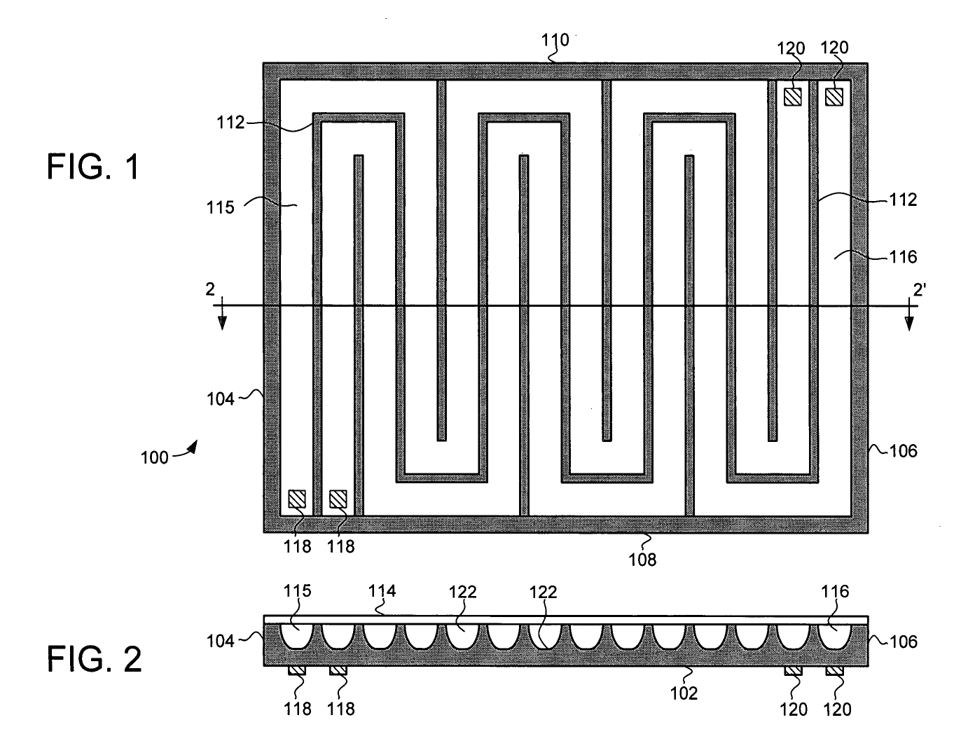

Turning now to FIGS. 1 and 2, a top view and a cross sectional view of an exemplary flat fluorescent lamp 100 is illustrated. Specifically, FIG. 1 shows a top view of flat lamp 100 and FIG. 2 shows a cross sectional view taken along line 2-2′ in FIG. 1. The flat lamp 100 includes a substrate 102 with two sidewalls 104 and 106 and two end walls 108 and 110 forming a rectangular perimeter. Substrate 102 is formed of any suitable material that is preferably rigid and self supporting, such as glass or ceramic. Two distinct channels 115 and 116 are formed in the substrate 102. The substrate 102, sidewalls 104 and 106, end walls 108 and 110, and channel walls 112 all combine to define the shape and structure of the channels 115 and 116. As will be described in greater detail below, the channels 115 and 116 are formed in a serpentine shape and interdigitated with each other. This allows the lamps formed in channels 115 and 116 to serve as replacements for each other. A transparent cover 114 is suitably attached to the substrate 102 such that the cover 102 and the top portion of the sidewalls 104 and 106, end walls 108 and 110, and channel walls 112 form two enclosures within the lamp 100. The transparent cover 114 is preferably formed of material having a coefficient of thermal expansion that matches substrate 102.

At least a portion of the enclosure interior (e.g., channels 115, 116) is coated with a material that fluoresces in the visible spectrum when bombarded with ultraviolet radiation. The fluorescent material may be of any material that produces light upon bombardment of ultraviolet radiation, such as phosphors, and more particularly, rare earth phosphors. Additionally, plasma or other ultraviolet emissive material such as mercury and argon is placed in the enclosure.

The plasma or other emissive material is ignited through sparking caused by the electric potential between two electrodes in the cathodes 118 and 120. Typically, filaments would be included in the cathodes 118 and 120 and extended into the lamp 100 for exiting the plasma or other ultraviolet emissive material. Cathodes 118 and 120 are suitably located at the end of each channel and exit at the bottom exterior of the substrate 102.

Typically, to create cathodes 118 and 120, small glass bodies contain the filaments with a glass frit, the glass frit having a lower melting point than that pf the filament housings 118 and 120. The cathodes 118 and 120 are typically soldered or otherwise attached to the bottom exterior of the substrate 102. Cathodes 118 and 120 are located at opposite ends of channels 115 and 116 that define the lamps to facilitate excitation of the plasma or other emissive material in the channels.

In the embodiment illustrated in FIGS. 1 and 2, the flat lamp system includes multiple interdigitated channels formed in the substrate. Specifically, the channels 115 and 116 are formed in a serpentine shape and interdigitated with each other. With this shape, each channel is adjacent to the other channel over substantially all its length. Because each channel closely tracks the other channel, the two lamps formed from the channels can serve as replacements for each other. Stated another way, when the flat lamp 100 is used in a display, the lamp formed in channel 115 and the lamp formed in channel 116 can each provide substantially equivalent luminance to the display. This allows the lamps formed in channels 115 and 116 to serve as replacements for each other in the display. Thus, if one lamp fails, the other lamp can serve as a substantially equivalent replacement Thus, by forming the channels interdigitated with each other, each of the multiple lamps can provide the light needed for the display and thus can effectively serve as replacement light sources for each other. This redundancy again can be used to improve the reliability of the display system.

It should be noted that flat lamp 100 is merely one exemplary embodiment of a multiple flat lamp system, and that many variations in structure could be used. As specific variations, additional serpentine channels can be formed to add additional lamps to the flat lamp system. As other examples, the channels can be formed with more or less length, changing the overall dimension of the flat lamp 100. In many cases it will be desirable to shape the channels in a way that best duplicates a tubular fluorescent lamp used in the same application.

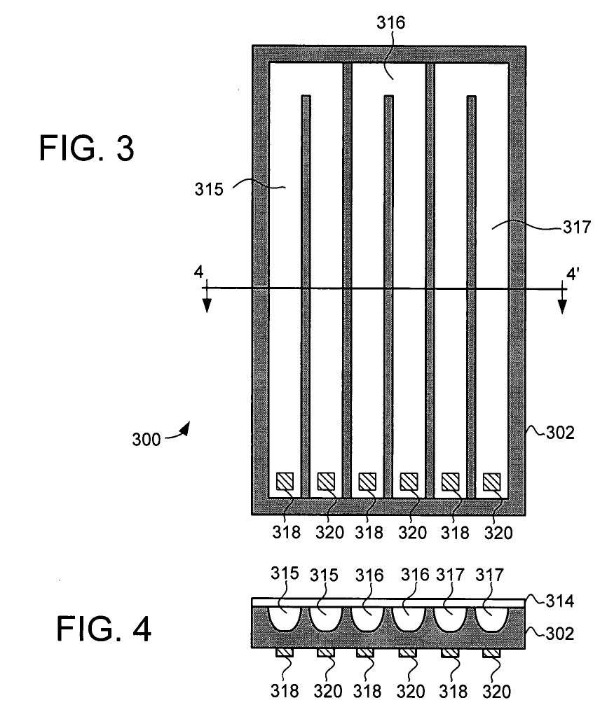

Turning now to FIGS. 3 and 4, a top view and a cross sectional view of a second embodiment exemplary flat fluorescent lamp 300 is illustrated. Specifically, FIG. 3 shows a top view of flat lamp 300 and FIG. 4 shows a cross sectional view taken along line 4-4′ in FIG. 3. Like the first embodiment, the flat lamp 300 includes a substrate 302. Three distinct channels 315, 316 and 317 are formed in the substrate 302 to provide three distinct lamps. A transparent cover 314 is suitably attached to the substrate 302 to form three enclosures within the lamp 300. At least a portion of the enclosure interior (e.g., channels 315, 316 and 317) is coated with a material that fluoresces in the visible spectrum when bombarded with ultraviolet radiation. Additionally, plasma or other ultraviolet emissive material such as mercury and argon is placed in the enclosure. Cathodes 318 and 320 are located at opposite ends of each of the channels 315, 316 and 317 that define the lamps to facilitate excitation of the plasma or other emissive material in the channels.

In the embodiment illustrated in FIGS. 3 and 4, the flat lamp system includes three channels formed in the substrate. Specifically, the channels 315, 316 and 317 are formed in a serpentine shape adjacent with each other. This embodiment thus provides three distinct lamps, meaning that it can provide a primary and two backup lamps for additional redundancy. Because the channels are of substantially equivalent dimensions, they can provide substantially equivalent luminance. However, because the channels form lamps that are not equivalent in terms of relative position, there may be some difference in the luminance provided to the display. However, this can generally be compensated for using appropriate feedback and control in the lamp driver circuit. Thus, if one lamp fails, the other lamps can serve as an effective replacement.

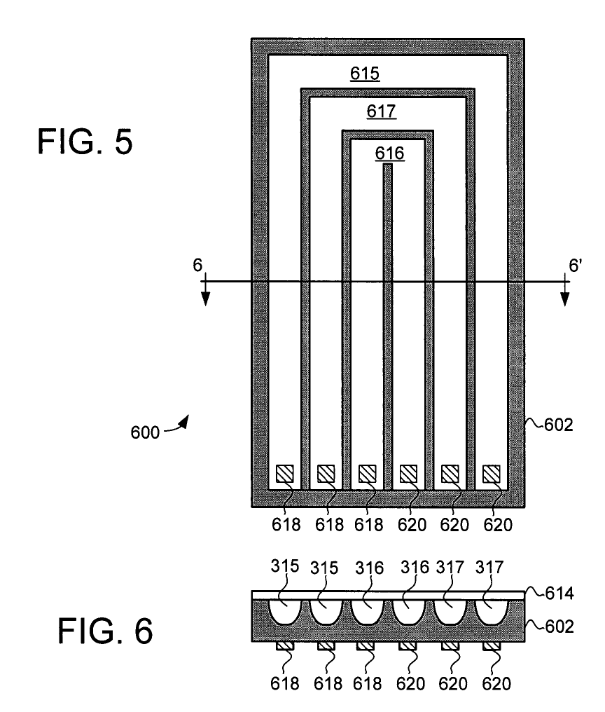

Turning now to FIGS. 5 and 6, a top view and a cross sectional view of a third embodiment exemplary flat fluorescent lamp 600 is illustrated. Specifically, FIG. 5 shows a top view of flat lamp 600 and FIG. 6 shows a cross sectional view taken along line 6-6′ in FIG. 5. Like the first and second embodiments, the flat lamp 600 includes a substrate 602. Three distinct channels 615, 616 and 617 are formed in the substrate 602 to provide three distinct lamps. A transparent cover 614 is suitably attached to the substrate 602 to form three enclosures within the lamp 600. At least a portion of the enclosure interior (e.g., channels 615, 616 and 617) is coated with a material that fluoresces in the visible spectrum when bombarded with ultraviolet radiation. Additionally, plasma or other ultraviolet emissive material such as mercury and argon is placed in the enclosure. Cathodes 618 and 620 are located at opposite ends of each of the channels 615, 616 and 617 that define the lamps to facilitate excitation of the plasma or other emissive material in the channels.

In the embodiment illustrated in FIGS. 5 and 6, the flat lamp system includes three channels formed in the substrate. Specifically, the channels 615, 616 and 617 are formed in a serpentine shape surrounding each other. This embodiment, like the second embodiment, thus provides three distinct lamps, meaning that it can provide a primary and two backup lamps for additional redundancy. In this embodiment, each channel is centered at the same location. However, in this embodiment, the channels are not of substantially equivalent dimensions. Because of this difference, there may be some difference in the luminance provided to the display. However, this again can generally be compensated for using appropriate feedback and control in the lamp driver circuit. Thus, if one lamp fails, the other lamps can serve as an effective replacement.

In addition to forming multiple lamps coplanar, a multiple lamp flat lamp system can be provided in a stacked configuration. The stacked flat lamp system can also facilitate improved reliability and performance by providing multiple independent lamps. In general, the stacked flat lamp system comprises a first flat lamp coupled to a second flat lamp. When the first lamp fails, the second lamp can be used to provide illumination to the display. Specifically, light from the second lamp can pass from the second lamp to the first lamp, where it can exit the first lamp and illuminate the display. Thus, either the first lamp or the second lamp can be used to provide illumination for the display. Thus, the first and second lamps provide redundancy, with this redundancy used to improve the reliability of the display system.

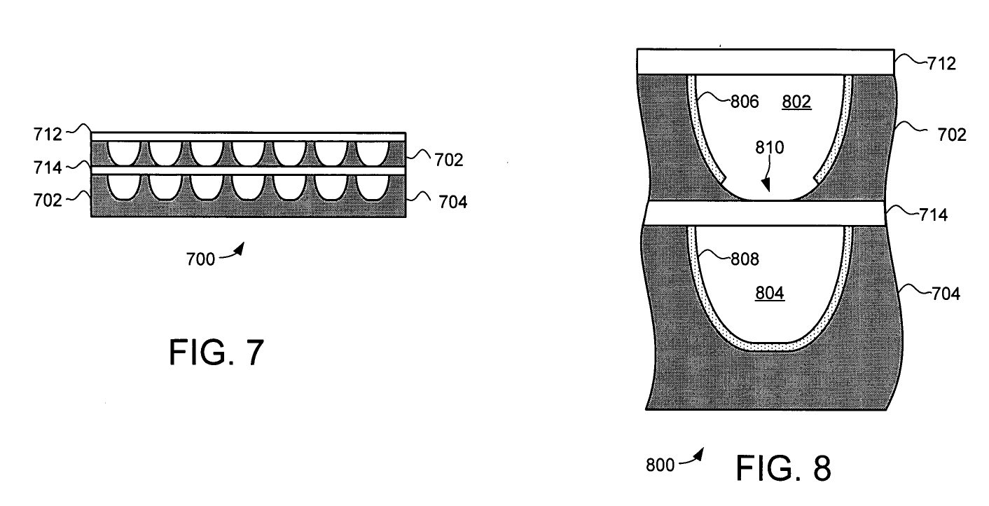

Turning now to FIG. 7 a cross sectional view of a fourth embodiment exemplary flat fluorescent lamp system 700 is illustrated. In this embodiment, the flat lamps are stacked to provide for an additional lamp for redundancy. The stacked flat lamp system 700 includes a first substrate 702 and a second substrate 704. At least one channel is formed in the first substrate 702 and at least one channel is formed in the second substrate 704 to provide at least two independent lamps. A first transparent cover 712 is suitably attached to the substrate 702 to form an enclosure within the first substrate 702. Likewise, a second transparent cover 714 is attached to the second substrate 704 to form an enclosure within the second substrate 704 and to provide connection to the first substrate 702. At least a portion of the each enclosures interior is coated with a material that fluoresces (e.g., phosphor) in the visible spectrum when bombarded with ultraviolet radiation. Additionally, plasma or other ultraviolet emissive material such as mercury and argon is placed in the enclosure. Cathodes are located at opposite ends of each of the each of the channels in each of the substrates to facilitate excitation of the plasma or other emissive material in the channels.

In the embodiment illustrated in FIG. 7, the flat lamp system 700 provides a first lamp in the first substrate 702 and a second lamp in the second substrate 704. When the first lamp fails or is otherwise inoperable, the second lamp can provided illumination through the channels of the first lamp. Specifically, light from the second lamp passes through the transparent cover 714 to the channels of the first lamp, where it can exit the first lamp and illuminate the display. Stated another way, the first lamp and the second lamp are coupled together such that light from either the first lamp or the second lamp can be used to provide illumination for the display. Thus, the first and second lamps provide redundancy, with this redundancy used to improve the reliability of the display system.

In order to improve the transmission of light from the second lamp in the second substrate 704 to the first lamp in the first substrate, it is generally desirable to omit a portion fluorescent material (e.g., phosphor) coating in the bottom region of the first lamp channel. As described above, the phosphor coating is an emissive material that fluoresces in the visible spectrum. During lamp operation, the emissive material emits electrons via thermionic emission caused by the electric potential between the two cathodes, causing the emissive material to fluoresce and provide light. The nature of the phosphor coating is such it can inhibit the transmission of light. Omitting the phosphor in the bottom region of the first lamp channel forms an “aperture” in the flat lamp that allows light to better pass from the second lamp to the first lamp.

Turning now to FIG. 8, a cross sectional view of a portion 800 of a stacked flat lamp is illustrated. The portion 800 includes a channel 802 in the first substrate 702 and a channel 804 in the second substrate 704. Formed inside the channel 802 is a first phosphor coating 806 and formed inside the channel 804 is a second phosphor coating 808. In the channel 802 the coating 806 is omitted from a narrow region that forms a coupling aperture 810. This coupling aperture 810 facilitates light transmission from the second lamp to the first lamp and thus improves the output capability of the flat lamp system when the second lamp is being utilized.

It should be noted that this is just one example of how flat lamps can be stacked to provide multiple lamps in the system. It should also be noted that the concept of a stacked lamp can be combined with the lamp systems where multiple lamps are formed co-planer in a single substrate. As one example, the flat lamp system 100 illustrated in FIGS. 1 and 2 can be combined in stacked configuration to provide four levels of redundancy.

In general, lamp driver systems are used to power lamps used in display systems. To fully provide lamp redundancy, it will be desirable in many applications to provide a lamp driver system that has the ability to switch between lamps. Such a system can determine when a failure has occurred in a lamp in the display and selectively drive the other lamp as a replacement. An example of such a lamp driver system is found in co-pending patent application “Lam Driver System with Improved Redundancy”, Ser. No. ______, filed on Oct. 31, 2003 and assigned to Honeywell International Inc.

It should also be noted that the lamp driver could be alternatively configured to drive both lamps simultaneously. For example, the lamp driver could be configured to drive the lamps with half the power going to each lamp. If one lamp is then lost, the lamp drive could adjust the power going to the remaining lamp to compensate for the loss in brightness. This method would have the possible advantage of extending the lifetime of the lamps due to the decreased power supplied to each lamp during normal operation.

The present invention thus provides a flat lamp system that facilitates improved reliability and performance in a display system. The flat lamp system provides improved reliability by forming multiple lamps in a single substrate. These multiple lamps provide redundancy and thus increase the reliability of system. Specifically, when one or more lamps in the system fails, the remaining lamps can be used to provide the luminance needed for the display. The multiple lamps are provided by forming multiple distinct channels in the substrate, and forming a cathode at each end of each channel. Each channel and its corresponding cathodes comprise a lamp that can be used to light the display.

The embodiments and examples set forth herein were presented in order to best explain the present invention and its particular application and to thereby enable those skilled in the art to make and use the invention However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit of the forthcoming claims.

1. A fluorescent lamp system comprising:
a substrate;
a first channel formed in the substrate;
a second channel formed in the substrate;
a cover lid attached to the substrate, the cover lid forming a first enclosure in the first channel and a second enclosure in the second channel; and
a fluorescent material in the first enclosure and the second enclosure to form a first lamp in the first enclosure and a second lamp in the second enclosure.

2. The fluorescent lamp of claim 1 wherein the first channel is interdigitated with the second channel.

3. The fluorescent lamp of claim 1 wherein the first channel and the second channel comprises serpentine shaped channels.

4. The fluorescent lamp of claim 1 wherein the first channel and the second channel comprises serpentine shaped channels and wherein the first channel is interdigitated with the second channel.

5. The fluorescent lamp of claim 1 further comprising a first a first set of cathodes formed in the first channel and a second set of cathodes formed in the second channel.

6. The fluorescent lamp of claim 1 further a third channel formed in the substrate to form a third enclosure defining a third lamp.

7. The fluorescent lamp of claim 1 further comprising:
a second substrate, the second substrate proximate the substrate;
a third channel formed in the second substrate, the third channel defining a third lamp, the third channel adjacent to the first channel in the substrate such that light can pass from the third lamp to the first lamp.

8. The fluorescent lamp of claim 7 further comprising a fourth channel formed in the second substrate to form a fourth lamp.

9. A fluorescent lamp system comprising:
a first substrate, the first substrate including a first channel;
a first pair of cathodes at the first channel, the first channel and the first pair of cathodes defining a first lamp;
a second substrate proximate to the first substrate, the second substrate including a second channel; and
a second pair of cathodes at the second channel, the second channel and the second pair of cathodes defining a second lamp.

10. The fluorescent lamp system of claim 9 the second substrate is proximate the first substrate such that the second channel is adjacent to the first channel such that light can pass from the second channel to the first channel.

11. The fluorescent lamp system of claim 9 wherein the first channel and the second channel are coated with a coating of fluorescent material, and wherein the coating of fluorescent material is omitted from a region in the first channel to define an aperture through which light can be transmitted from the second channel to the first channel.

12. The fluorescent lamp system of claim 11 wherein the first channel includes a bottom interior side and wherein the fluorescent material is omitted from the bottom interior side of the first channel to define the aperture.

13. The fluorescent lamp system of claim 9 wherein the first substrate is coupled to the second substrate through a transparent cover on the second substrate.

14. The fluorescent lamp system of claim 9 further comprising:
a third channel formed in the first substrate, and
a third pair of cathodes formed at the third channel, the third channel and third pair of cathodes defining a third lamp.

15. The fluorescent lamp system of claim 14 further comprising:
a fourth channel formed in the second substrate, and
a fourth pair of cathodes formed at the fourth channel, the fourth channel and fourth pair of cathodes defining a fourth lamp.

16. The fluorescent lamp system of claim 14 wherein the third channel is adjacent the fourth channel such that light can pass from the fourth channel to the third channel.

17. A fluorescent lamp system comprising:
a first substrate;
a first serpentine channel formed in the first substrate;
a second serpentine channel formed in the first substrate, the second serpentine channel interdigitated with the first serpentine channel;
a first pair of electrodes formed in the first serpentine channel;
a second pair of electrodes formed in the second serpentine channel;
a cover lid attached to the substrate, the cover lid forming a first enclosure in the first serpentine channel and a second enclosure in the second serpentine channel;
a first fluorescent material in the first enclosure, the first fluorescent material, the first pair of electrodes and the first channel defining a first lamp; and
a second fluorescent material in the second enclosure, the first fluorescent material, the second pair of electrodes and the second channel defining a second lamp.

18. The fluorescent lamp system of claim 17 further comprising:
a second substrate adjacent to the first substrate;
a third serpentine channel formed in the second substrate;
a fourth serpentine channel formed in the second substrate, the fourth serpentine channel interdigitated with the third serpentine channel;
a third pair of electrodes formed in the third serpentine channel;
a fourth pair of electrodes formed in the fourth serpentine channel;
a transparent lid attached between the first substrate and the second substrate, the transparent lid forming a third enclosure in the third serpentine channel and a fourth enclosure in the fourth serpentine channel;
a third fluorescent material in the third enclosure, the third fluorescent material, the third pair of electrodes and the third channel defining a third lamp; and
a fourth fluorescent material in the fourth enclosure, the fourth fluorescent material, the fourth pair of electrodes and the fourth channel defining a fourth lamp.
